(19) United States
(12) Patent Application Publication
(10) Pub. No.: US 2020/0204960 A1
(43) Pub. Date: Jun. 25, 2020

(54) CONTROL METHOD FOR ELECTRONIC DEVICE

(71) Applicant: ASUSTEK COMPUTER INC., Taipei (TW)

(72) Inventors: Po-Han LIN, Taipei (TW); Shang-Yu HUNG, Taipei (TW); Meng-Heng HO, Taipei (TW)

(21) Appl. No.: 16/726,459

(22) Filed: Dec. 24, 2019

(30) Foreign Application Priority Data
Dec. 24, 2018 (TW) 107146835

(51) Int. Cl. H04W 4/08; H04W 56/00; H04W 12/06

(52) U.S. Cl. CPC H04W 4/08; H04W 84/12; H04W 12/06; H04W 56/0015

(57) ABSTRACT

A control method for an electronic device is provided. Firstly, a host device establishes a group and sets an effect with respective to the group. Then, the host device determines that whether a client device joins in the group or not. When the client device joins in the group, the host device transmits a synchronization signal at a predetermined time interval to the client device to synchronize timing of the effect of the host device and the client device.

### CROSS-REFERENCE TO RELATED APPLICATION

This application claims the priority benefit of Taiwan Application Serial No. 107146835, filed on Dec. 24, 2018. The entirety of the above-mentioned patent application is hereby incorporated by reference herein and made a part of the specification.

### BACKGROUND OF THE INVENTION

### Field of the Invention

The disclosure relates to an electronic device, and more particularly to a control method for synchronizing a plurality of electronic devices.

### Description of the Related Art

In some venues such as game arenas or concerts, people usually light the flashes of their mobile phones to create a visual shock to highlight the cohesiveness of their teams or groups.

However, at present, the participants spontaneously control the flashes of their mobile phones and coordinate with each other to present the visual shock. Such a control manner fails to effectively unify the effects of the flashes of the mobile phones of all the participants, affecting the overall visual effect presented.

### BRIEF SUMMARY OF THE INVENTION

The disclosure provides a control method for an electronic device, applied to a host device. A control method for an electronic device, applied to a host device, the control method comprising the following steps: establishing, by the host device, a group and setting an effect with respect to the group; determining, by the host device, whether a client device joins in the group or not; and transmitting, by the host device, a synchronization signal at a predetermined time interval to the client device in the group to synchronize timing of the effect of the host device and the client device, when the client device joins in the group.

A conventional mobile phone control device fails to effectively unify the effects of flashes of mobile phones of all participants in a group, affecting the overall visual effect presented by the group. In comparison, the control method for an electronic device according to the disclosure synchronizes the effect of the host device and the client device by using the synchronization signal, to effectively unify the effects of electronic devices of all participants in the group, thereby improving the overall visual or auditory effect. The control method for an electronic device, when applied to a game arena, effectively highlights the cohesiveness of a team.

Specific embodiments of the disclosure will be further described by using the following embodiments and drawings.

### BRIEF DESCRIPTION OF THE DRAWINGS

FIG. 1 is a schematic block diagram of an embodiment of a control method for an electronic device according to the disclosure;

FIG. 2 is a schematic block diagram of an embodiment of an electronic device applied to the disclosure;

FIG. 3 is a schematic diagram of an embodiment of a light-emitting module of an electronic device applied to the disclosure; and

FIG. 4 is a schematic block diagram of another embodiment of a control method for an electronic device of the disclosure.

### DETAILED DESCRIPTION OF THE EMBODIMENTS

Specific embodiments of the disclosure will be described in further detail below with reference to schematic drawings. The advantages and features of the disclosure will become more apparent from the following description and claims. It should be noted that the drawings are all in a very simplified form and are not drawn to accurate scale, but are merely used for convenience and clarity of description of the embodiments of the disclosure.

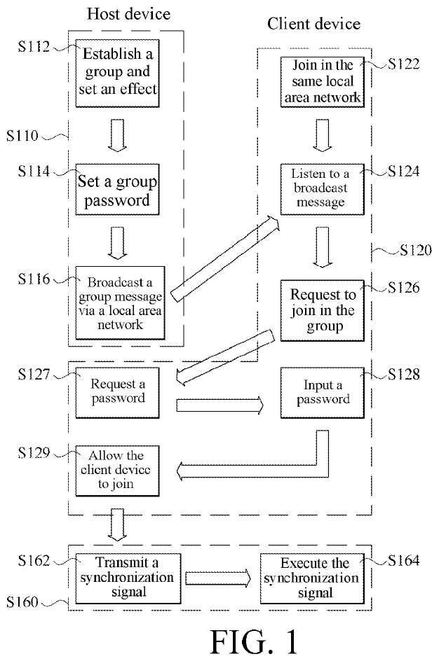

FIG. 1 is a schematic block diagram of an embodiment of a control method for an electronic device according to the disclosure. The control method is used to coordinate a plurality of electronic devices and synchronize effects of the electronic devices. In an embodiment, the effect is emitting light, producing a sound, or the like. The electronic devices include a host device and at least one client device (in the figure, one client device is taken as an example). The left part of the figure represents operations executed by the host device, and the right part of the figure represents operations executed by the client device. In an embodiment, the electronic device is a handheld electronic device such as a mobile phone. Any electronic device with a wireless communication function is applied to the disclosure. The control method includes the following steps.

Firstly, as shown in step S110, after a host device is selected, the host device establishes a group and sets an effect with respect to the group. In an embodiment, the host device is predetermined, or an electronic device establishing the group is directly set as the host device.

Then, as shown in step S120, the host device determines whether a client device joins in the group established by the host device or not. In the figure, one client device is taken as an example. In electronic devices in a same local area network, an electronic device not designated as the host device serves as a client device.

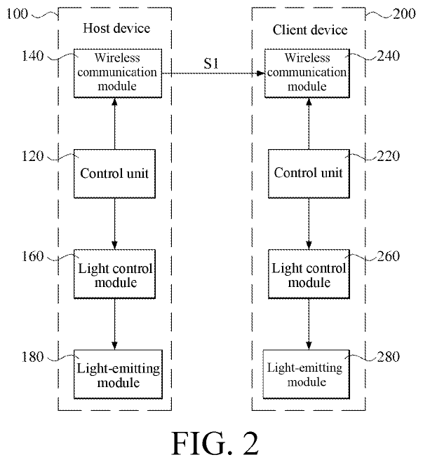

Afterward, as shown in step S160, the host device transmits a synchronization signal at a predetermined time interval to each client device in the group to synchronize timing of the effect of the host device and the client device, when the client device joins in the group. In an embodiment, as shown in the figure, after receiving the synchronization signal, the client device executes the synchronization signal and generates the effect according to the synchronization signal. In an embodiment, the effect is emitting light or producing a sound. Specific configurations of the host device and the client device will be described below in further detail with reference to FIG. 2.

According to the above-mentioned control method, not only timing of the effects of all the client devices in the group is synchronized, but also timing of the effect of the host device and the client device is synchronized, to effectively unify the effects of all the electronic devices in the group, thereby improving the overall visual or auditory effect.

In an embodiment, the synchronization signal is a light-emitting control signal to control the client device to emit light. After receiving the light-emitting control signal, the client device executes the light-emitting control signal and emits light according to a light-emitting mode defined by the light-emitting control signal.

In another embodiment, the synchronization signal is a light-emitting time signal to inform all the client devices of a mode and a time point of next time of light emission. In another embodiment, the synchronization signal is a sound production control signal to control the client device to produce a sound.

As shown in the figure, in an embodiment, the above-mentioned step S110, that is, the step of establishing the group by the host device, includes the following steps.

Firstly, as shown in step S112, after the host device is selected, the host device establishes the group and sets the effect.

Then, as shown in step S114, after establishing the group, the host device sets a group password.

Afterward, as shown in step S116, the host device broadcasts a group message via a local area network, and informs other electronic devices (namely, client devices) in the local area network of the existence of the group. In an embodiment, the local area network is a WiFi network. In an embodiment, the group message includes a group name, a host device identity, and the like. Each client device selects whether to join in the group according to the group message.

As shown in the figure, in an embodiment, the above-mentioned step S120, that is, the step the host device determines that whether the client device joins in the group or not, includes the following steps.

Firstly, as shown in step S122, the client device is added to the local area network to which the host device is connected. In a case that the client device is already connected to the local area network in advance, this step is omitted.

Then, as shown in step S124, the client device detects the group message broadcast by the host device, determines the identity of the host device, and determines whether to join in the group.

When the client device joins in the group, as shown in step S126, the client device transmits a join request to the host device.

Afterward, the host device performs identity verification on the client device by using the group password. In an embodiment, as shown in step S127, after receiving the join request, the host device requests the client device for a group password. After receiving the request, as shown in step S128, the client device inputs a group password for confirmation by the host device. After the host device receives the group password input by the client device and determines that the password is correct, as shown in step S129, the host device allows the client device to join in the group, thus completing the joining procedure.

In the foregoing embodiment, the host device performs identity verification on the client device by using the group password, so as to determine whether to allow the client device to join in the group. In another embodiment, the host device does not set the group password, and directly accepts a join request from any client device allowed to access the local area network.

FIG. 2 is a schematic block diagram of an embodiment of an electronic device applied to the disclosure. The left part of the figure shows a host device 100, and the right part shows a client device 200, to illustrate interaction between the host device 100 and the client device 200.

The group effect of the electronic device in this embodiment is emitting light. According to practical requirements, the electronic device of the disclosure is also applied to producing a sound or other group effects.

As shown in FIG. 2, the host device 100 includes a control unit 120, a wireless communication module 140, a light control module 160, and a light-emitting module 180, and the client device 200 includes a control unit 220, a wireless communication module 240, a light control module 260, and a light-emitting module 280. As required, the client device 20 and the host device 100 are exchangeable.

When the host device 100 needs to control the client device 200 to emit light, the control unit 120 of the host device 100 transmits a synchronization signal 51 to the client device 200 via the wireless communication module 140 by broadcasting via a local area network or other means. The control unit 220 of the client device 200 receives the synchronization signal 51 via the wireless communication module 240, and controls, through the light control module 260 according to the synchronization signal 51, the light-emitting module 280 to emit light.

On the other hand, while transmitting the synchronization signal 51, the control unit 120 of the host device 100 also controls, through the light control module 160, the light-emitting module 180 to emit light. In this way, light emission of the host device 100 and light emission of the client device 200 are synchronized.

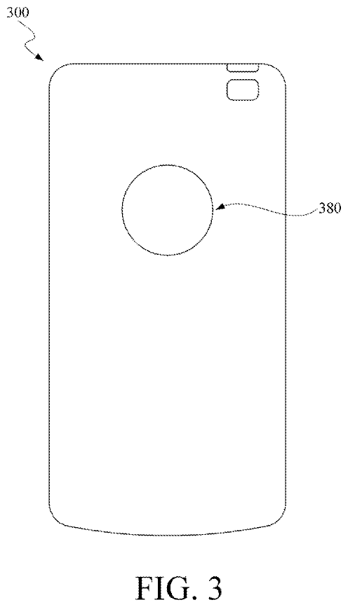

FIG. 3 is a schematic diagram of an embodiment of a light-emitting module of an electronic device applied to the disclosure. In the figure, a handheld electronic device is taken as an example. As shown in the figure, in an embodiment, a light-emitting module 380 of the electronic device 300 is disposed on a rear side of the electronic device 300. In an embodiment, the light-emitting module 380 is a light-emitting logo. In an embodiment, the light-emitting module is a flash module of the electronic device 300. In an embodiment, the light-emitting module is a display panel of the electronic device 300.

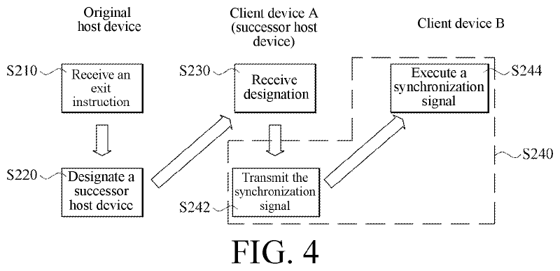

FIG. 4 is a schematic block diagram of another embodiment of a control method for an electronic device of the disclosure. The control method of this embodiment is applied to a case where a host device needs to exit, such as a case where the game character of the host device is killed in a battle in an online game or the host device is lack of power when playing an online game. The control method involves the host device and at least two client devices (in the figure, a client device A and a client device B are taken as examples). The left part of the figure represents operations executed by an original host device, the middle part represents operations executed by the client device A (a successor host device), and the right part represents operations executed by the client device B.

As shown in step S210, when the game character of the host device is killed in a battle in an online game, the host device receives an exit instruction. Then, as shown in step S220, the host device designates one (the client device A) of the client devices (namely, the client device A and the client device B) remaining in the group as a successor host device to take charge of the original group.

Then, as shown in step S230, after accepting the designation of the host device, the client device A becomes the successor host device of the group. Afterward, as shown in step S240, the successor host device transmits a synchronization signal at a predetermined time interval to the client device (namely, the client device B) in the group to control timing of the effect of the client device B. In an embodiment, after receiving the synchronization signal, the client device B executes the synchronization signal and generates the effect according to the synchronization signal. In an embodiment, the effect is emitting light or producing a sound. In an embodiment, the successor host device broadcasts a group message via a local area network to inform the other electronic device (namely, the client device B) in the local area network of the change of the host device.

According to the foregoing control method, when the original host device is forced to exit, it is not necessary to reselect a host device to establish a new group and invite other client devices to join in the new group, but instead, the successor host device directly takes charge of the original group. Therefore, the control method simplifies the related procedure without affecting operations executed by other client devices in the group.

To sum up, a conventional mobile phone control device fails to effectively unify the effects of flashes of mobile phones of all participants in a group, affecting the overall visual effect presented by the group. In comparison, the control method for an electronic device according to the disclosure synchronizes the effect of the host device and the client device by using the synchronization signal, to effectively unify the effects of electronic devices of all participants in the group, thereby improving the overall visual or auditory effect. The control method for an electronic device, when applied to a game arena, effectively highlights the cohesiveness of a team.

The foregoing descriptions are merely preferred embodiments of the disclosure and are not intended to limit the disclosure in any way. Any person skilled in the art can make any form of equivalent replacement or modification to the technical means and technical contents disclosed by the disclosure without departing from the scope of the technical means of the disclosure, and such equivalent replacement or modification does not depart from the contents of the technical means of the present disclosure and still falls within the protection scope of the disclosure.

What is claimed is:

1. A control method for an electronic device, applied to a host device, the control method comprising:
establishing, by the host device, a group and setting an effect with respect to the group;
determining, by the host device, whether a client device joins in the group or not; and
transmitting, by the host device, a synchronization signal at a predetermined time interval to the client device in the group to synchronize timing of the effect of the host device and the client device when the client device joins in the group.

2. The control method according to claim 1, wherein the electronic device is a handheld electronic device.

3. The control method according to claim 1, wherein the synchronization signal is a light-emitting control signal to control the client device in the group to emit light.

4. The control method according to claim 1, wherein the synchronization signal is a sound production control signal to control the client device in the group to produce a sound.

5. The control method according to claim 1, wherein the step of establishing the group by the host device comprises:
setting a group password; and
broadcasting a group message via a local area network.

6. The control method according to claim 5, wherein the step of determining by the host device whether the client device joins in the group or not comprises:
detecting, by the client device, the group message and determining the host device;
transmitting, by the client device, a join request to the host device; and
performing, by the host device, identity verification by using the group password.

7. The control method according to claim 5, wherein the local area network is a WiFi network.

8. The control method according to claim 1, further comprising:
designating, by the host device when receiving an exit instruction, one of client devices in the group as a successor host device to transmit the synchronization signal at the predetermined time interval to the client device.
